(19) United States
(12) Patent Application Publication
(10) Pub. No.: US 2009/0249695 A1
(43) Pub. Date: Oct. 8, 2009

(54) DAMP RAIL ASSEMBLY FOR GARAGE DOOR OPENING SYSTEMS

(75) Inventor: Dhaval Jain, Farmington Hills, MI (US)

Correspondence Address: QUINN LAW GROUP, PLLC, 39555 ORCHARD HILL PLACE, SUITE # 520, NOVI, MI, 48375, US

(73) Assignee: MATERIAL SCIENCES CORPORATION, Elk Grove Village, IL (US)

(21) Appl. No.: 12/062,562

(22) Filed: Apr. 4, 2008

(51) Int. Cl. E05D 15/00

(52) U.S. Cl. 49/148

(57) ABSTRACT

A damp rail assembly for a garage door opening system is provided. The rail assembly includes a beam member configured for mounting to a support structure, and for slidably supporting a trolley member. A viscoelastic laminate structure is attached to the beam member to absorb and attenuate vibration and structure-borne noise directly therefrom. The viscoelastic laminate structure includes a constraining layer and a viscoelastic layer spanning substantially the entirety of the constraining layer and bonded thereto. The viscoelastic laminate structure may include a plurality of planar viscoelastic laminate structures each having an adhesive layer spanning substantially the entirety of a respective viscoelastic layer such that each of the planar viscoelastic laminate structures may be individually adhered at different predetermined locations along the beam member. Alternatively, the viscoelastic laminate structure and beam member may be preformed as a single, unitary structure.

### TECHNICAL FIELD

The present invention relates generally to garage door opening systems, and more particularly to devices for minimizing vibration and damping noise generated by garage door opening systems.

### BACKGROUND OF THE INVENTION

Garage door opening systems are motorized devices for selectively opening and closing garage doors. Such systems often include a reversible motor for driving a gear system in driving communication with a chain, belt, or screw, which is connected in turn to a trolley. The trolley, which is attached to the garage door by a drawbar, is driven along a rail assembly to move the door between its opened and closed positions. The drive motor and gear system are generally packaged in a single housing unit, known as the garage door opener head, which is mounted to a supporting structure, such as the garage ceiling, by metal mounting brackets. Conventionally, the garage door itself is mounted to a rail system, which often includes travel-limiting devices to stop the door's movement at the fully opened and fully closed positions.

Driving the motor in one direction will open the door, while driving the motor in the opposite direction will close the door. Opening and closing of the garage door is often assisted by a counterbalance system, which uses torsion springs or linear expansion springs to bias the garage door in one direction. Garage door opening systems have traditionally been controlled by switches on the garage wall, as well as by remote control devices.

Air-borne noise may be generated through operation of the garage door opener system. Noise and vibration can be transmitted to the unit's cover, and radiated from the cover into the surrounding environment. Vibration produced by the motor and gear system can also be transmitted through the mounting brackets to the structure to which the motor is mounted. Efforts have been made to reduce the vibration and resultant noise generated by garage door opener assemblies. All prior art approaches, however, have been limited to making the motor and associated gears and linkages operate as smoothly and quietly as possible. For example, some prior art systems propose to use rubber isolators to segregate the drive motor from the structure to which the motor is mounted. Other approaches propose to add damping treatments to the main body portion of the garage door head.

### SUMMARY OF THE INVENTION

The present invention breaks from current practices by focusing on structure borne noise generated by the rail assemblies of the garage door opening system. Although the prior art approaches—e.g., applying damping treatments to the garage door head cover or using rubber isolators on the mounting brackets, do help in reducing the vibration, and hence the overall noise emission and noise character in designs where the garage door head is the dominant source of noise, these methods fail where the rail assembly is the dominant source of noise. Consequently, the present invention proposes to integrate a viscoelastic laminate structure, preferably in the nature of a stick-on material or laminated steel, into the garage door opener rail assembly. A damp rail in accordance with the present invention adds mass and improved damping characteristics to the rail assembly, reducing the vibration and, thus, the noise emission from the rail assembly.

According to one embodiment of the present invention, a rail assembly for a door opening system is provided. The door opening system includes a prime mover in driving communication with a trolley that is operatively attached to a movable door, such as a garage door. The prime mover is operable to selectively reposition the trolley and thereby transition the movable door between a substantially closed and a generally open position. The rail assembly includes one or more beam members configured for mounting to a support structure, and to slidably support the trolley member thereon. A viscoelastic laminate structure is attached to the beam member to dissipate structure-borne noise generated therefrom.

According to one aspect of the present embodiment, the viscoelastic laminate structure includes a constraining layer, and a viscoelastic layer spanning substantially the entirety of and bonded to the constraining layer. The viscoelastic laminate structure may include a plurality of planar viscoelastic laminate structures. In this instance, each of the planar viscoelastic laminate structures preferably includes an adhesive layer spanning substantially the entirety of a respective viscoelastic layer such that each of the planar viscoelastic laminate structures may be individually adhered at different predetermined locations along the beam member. Alternatively, the viscoelastic laminate structure and beam member may be preformed as a single, unitary structure.

In another aspect of the present embodiment, the constraining layer comprises one of a metallic material and a polymeric material. Ideally, the constraining layer is steel.

In accordance with yet another aspect, the viscoelastic material is either a natural rubber or a synthetic material.

According to yet another aspect, the beam member has either a box-shaped cross-section or a t-shaped cross-section.

According to another embodiment of the present invention, a garage door opening system for a movable garage door is provided. The garage door opening system includes a beam member configured for mounting to a support structure, such as a garage ceiling. A trolley is operatively attached to the movable door, and slidably supported on the beam member to transition between first and second positions. A motor is in driving communication with the trolley to selectively reposition the trolley between the first and second positions, and thereby transition the movable door between a substantially closed and a generally open position. A viscoelastic laminate structure is attached to the beam member to absorb and attenuate vibration and structure-borne noise directly therefrom.

According to one aspect of the present embodiment, the viscoelastic laminate structure includes a constraining layer, and a viscoelastic layer spanning substantially the entirety of the constraining layer. The viscoelastic layer is disposed between and bonded to the constraining layer and the beam member. The viscoelastic laminate structure may include a plurality of planar viscoelastic laminate structures, each preferably having an adhesive layer spanning substantially the entirety of a respective viscoelastic layer such that each of the planar viscoelastic laminate structures may be individually adhered at different predetermined locations along the beam member. Alternatively, the viscoelastic laminate structure and beam member may be preformed as a single, unitary structure.

The above features and advantages, and other features and advantages of the present invention will be readily apparent from the following detailed description of the preferred embodiments and best modes for carrying out the present invention when taken in connection with the accompanying drawings and appended claims.

### BRIEF DESCRIPTION OF THE DRAWINGS

FIG. 1 is a schematic side-view illustration of a representative garage door opening system with a damp rail assembly in accordance with the present invention;

FIG. 2 is a schematic cross-sectional illustration of a portion of the damp rail assembly of FIG. 1 in accordance with one embodiment of the present invention;

FIG. 3 is a schematic cross-sectional illustration of a portion of the damp rail assembly of FIG. 1 in accordance with another embodiment of the present invention; and

FIG. 4 is a schematic cross-sectional illustration of a portion of the damp rail assembly of FIG. 1 in accordance with yet another embodiment of the present invention.

### DESCRIPTION OF THE PREFERRED EMBODIMENT

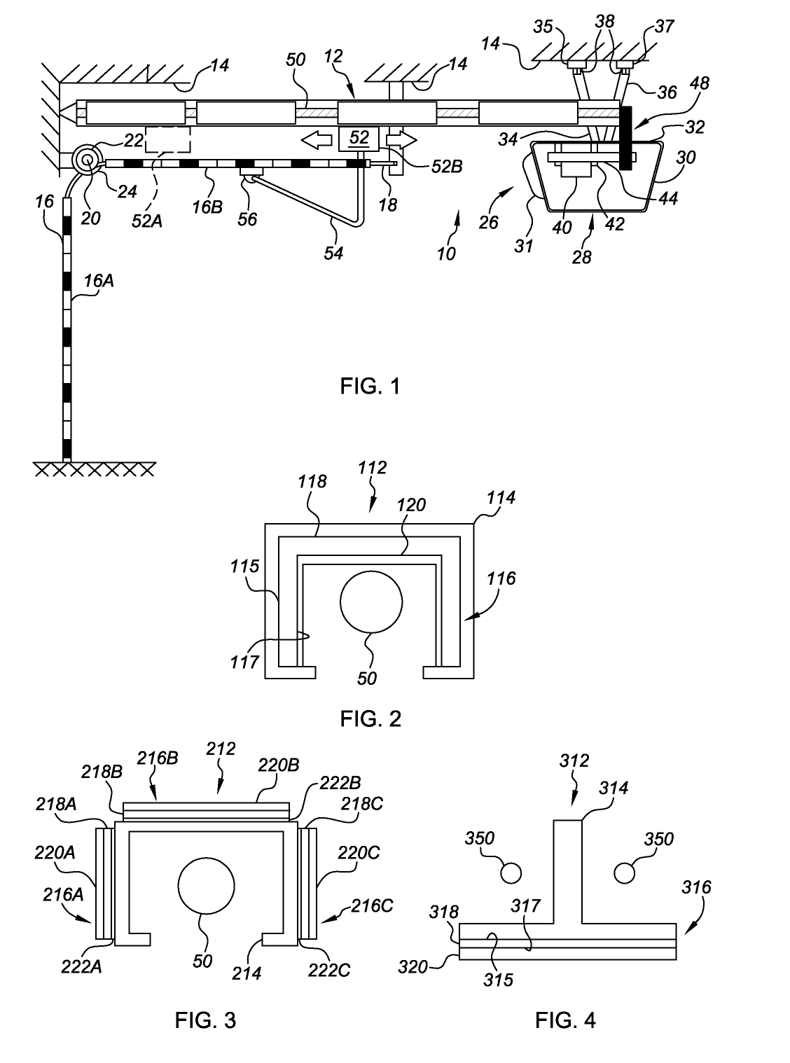

Referring to the drawing, wherein like reference numbers refer to like components throughout the several views, FIG. 1 schematically illustrates a representative garage door opening system, indicated generally at 10, utilizing a damp rail assembly 12 in accordance with the present invention. It should be understood that FIG. 1 is merely a representative application by which the present invention may be incorporated. As such, the present invention is by no means limited to the particular configuration of FIG. 1. In addition, the drawings presented herein—i.e., FIGS. 1 through 4, are not to scale and are provided purely for instructional purposes. Thus, the specific and relative dimensions shown in the drawings are not to be considered limiting.

The garage door opener assembly 10 is mounted to a support structure 14, such as, but not limited to, the ceiling of a residential garage. A movable garage door 16 is respositionably mounted to a rail assembly, illustrated in part in FIG. 1 by rail 18, to transition between a closed position 16A and an open position 16B. The garage door 16 is shown in FIG. 1 as an overhead, folding-type design, but may comprise any practical configuration without departing from the scope of the present invention.

A shaft 20 is rotatably mounted above the garage door 10 on a wall of the support structure 14. The shaft 20 carries a torsion spring 22. The shaft 20 and torsion spring 22, in conjunction with a variety of cables and pulleys, indicated collectively as 24, act as a counterbalance system. In other words, the pulleys and cables 24, which attach the shaft 20 to the garage door 16, act so as to counter balance the weight of the door 16 by spring biasing the garage door 16 into the open position 16B.

The primary components of the garage door opener assembly 10, as seen in FIG. 1, include a garage door operator 26 (referred to hereinafter as “garage door head”) and a damp rail assembly, indicated generally at 12. The garage door head 26 includes a main body or housing 28 comprising a cover portion 30 with a light 31, the cover portion 30 being attached to a support portion 32. The cover portion 30 is partially broken away in FIG. 1 for clarity of the components housed within the main body 28. The garage door head 26 is attached to the support structure 14, generally by suspending the head support portion 32 from first and second hanger bracket arms 34 and 36, respectively. Each hanger bracket arm 34, 36 includes a respective flange portion 35 and 37 through which slots are formed to receive bolts 38.

A prime mover, such as electric motor 40, is housed within the main body 28, attached to the support portion 32 by a fixture 42. A motor output shaft 44 extends out from the electric motor 40 to rotate a belt drive system, indicated collectively at 48. The belt drive system 48 typically includes a drive pulley rigidly attached to the motor output shaft 44, and a flexible, continuous belt coupling the drive pulley with a driven pulley. Alternatively, a conventional gear train may replace the belt drive system 48. The belt drive system 48 is connected in turn to a power screw 50. As an alternative to the power screw 50, the garage door opening system 10 may include a chain drive system, as indicated in FIG. 4, in power flow communication with the belt drive system 48. Moreover, the electric motor 40 may be placed in direct driving communication with power screw 50—i.e., eliminating element 48 from FIG. 1. Other various electrical components which are not shown in FIG. 1 are contained in the main body 28.

The damp rail assembly 12, as seen in FIG. 1, is elongated along and mounted to the support structure 14, intermediate the garage ceiling and garage door head 26. A trolley 52 is slidably attached to the damp rail assembly 12 to transition, along a generally rectilinear path, between a first position (shown hidden as 52A) and a second position (identified as 52B in FIG. 1). For example, the electric motor 40 is in driving communication with the trolley 12—i.e., via the interconnection between output shaft 44, belt drive system 48, and power screw 50, to selectively reposition the trolley 52 between the first and second positions 52A, 52B. It is by this means that the electric motor 40 is operable to transition the garage door 16 between closed 16A and open 16B positions. The trolley 52 has a control arm, such as generally L-shaped drawbar 54, which is attached by a pivot hinge 56 to the garage door 16 such that, as the trolley 52 is moved along to the rail assembly 12, the garage door 16 can be opened and closed.

A schematic illustration of a portion of the damp rail assembly of FIG. 1 is shown in FIG. 2 in accordance with one embodiment of the present invention. The damp rail assembly of FIG. 2, indicated generally as 112, includes a tubular, box-shaped beam member 1 14. The beam member 114 is preferably fabricated from a material having sufficient structural rigidity for mounting to the support structure 14 (FIG. 1), and to provide adequate support for the trolley member 52. By way of example, the beam member 114 is preferably fabricated from either a metallic or a polymeric material, which may include, but is not limited to, plastics, aluminum, magnesium, titanium, and steel.

A viscoelastic laminate structure, indicated generally at 116, is attached to the beam member 114 to absorb and attenuate vibration and structure-borne noise directly from the beam member 114. “Structure borne noise” is noise which travels over at least part of its path by means of the vibration of a solid structure—e.g., the vibrations exciting walls and slabs in buildings, causing them to radiate noise. In accordance with preferred practices, the viscoelastic laminate structure 116 and beam member 114 are preformed as a single, unitary structure. Specifically, the damp rail assembly 112 of FIG. 2 is formed as a constrained layer viscoelastic material. In this regard, the viscoelastic laminate structure 116 includes an engineered viscoelastic layer 118 enclosed or surrounded, at least in part, by a constraining layer 120 and the beam member 114 (acting as a secondary constraining layer).

The viscoelastic layer 118 spans substantially the entirety of the constraining layer 120, and is bonded, attached or adhered (e.g., by a high tack polymer) to the beam member 114 along an outer interface surface 115, and similarly attached along an inner interface surface 117 to the constraining layer 120. The viscoelastic layer 118 is fabricated from either a natural rubber or a synthetic material, preferably in the nature of a high strength damping polymer. In addition, the constraining layer 120 is formed from a material with the necessary stiffness to provide support to the viscoelastic layer 118, such as polymers, plastics, aluminum, magnesium, titanium, and steel. In accordance with preferred practices, the material for the beam member 114 and constraining layer 120 is draw quality cold rolled steel.

Notably, the beam member 114 and constraining layer 120 may be of similar or distinct thicknesses and materials. The beam member 114 and constraining layer 120 may be finished with an electro-galvanized coating (not shown) for corrosion resistance. In addition, those skilled in the art will recognize that the viscoelastic laminate structure 116 may include extra layers in addition to the viscoelastic layer 118. Finally, the thickness and composition of the viscoelastic layer 118 may be modified to tailor to the composite loss factor, bond strength, overall stiffness of the viscoelastic laminate structure 116, as well as additional properties dictated by the specific application.

Referring now to FIG. 3, a portion of the damp rail assembly of FIG. 1 is shown in accordance with another embodiment of the present invention. The damp rail assembly of FIG. 3, which is indicated generally as 212, includes a tubular, box-shaped beam member 214. For the purposes of brevity, the beam member 214 of FIG. 3 should be considered structurally identical to the beam member 114 of FIG. 2.

A plurality of “stick-on” viscoelastic laminate structures, presented in FIG. 3 as first, second and third planar viscoelastic laminate structures 216A, 216B and 216C, respectively, are attached to the beam member 114 to absorb and attenuate vibration and structure-borne noise directly from the beam member 114. More specifically, each of the planar viscoelastic laminate structures 216A-216C includes a respective viscoelastic layer 218A, 218B and 218C, enclosed or surrounded on one side by a respective constraining layer 220A, 220B and 220C, and on the other side by the beam member 214 (acting as a secondary constraining layer). The viscoelastic layers 218A-218C are fabricated from either a natural rubber or a synthetic material, preferably in the nature of a high strength damping polymer. In addition, the constraining layers 220A-220C are formed from a material with the necessary stiffness to provide support to the viscoelastic layers 218A-218C, such as polymers, plastics, aluminum, magnesium, titanium, and steel.

The viscoelastic layers 218A-218C span substantially the entirety of their respective constraining layer 220A-220C, and each is bonded, attached or adhered thereto (e.g., by a high tack polymer). According to the embodiment of FIG. 3, first, second and third adhesive layers 222A, 222B and 222C, respectively, span substantially the entirety of each respective viscoelastic layer 218A-218C such that each of the viscoelastic laminate structures 216A-216C may be individually adhered at different predetermined locations along the beam member 214.

A schematic illustration of a damp rail assembly in accordance with yet another embodiment of the present invention is shown in FIG. 4. As noted above, the embodiment of FIG. 4 is intended to illustrate a garage door opening system utilizing a chain drive system, which typically includes a driving sprocket (not shown) spaced apart from a driven sprocket (not shown), both intermeshed with an endless power transmission chain 350, to transition the movable door (e.g., garage door 16 of FIG. 1) between open and closed positions. The damp rail assembly of FIG. 4, indicated generally as 312, includes a T-shaped beam member 314. For the purposes of brevity, the beam member 314 of FIG. 4 should be considered structurally identical to the beams member 114 and 214 of FIGS. 2 and 3.

A viscoelastic laminate structure, indicated generally at 316, is attached to the beam member 314 to absorb and attenuate vibration and structure-borne noise directly from the beam member 314. In accordance with preferred practices, the viscoelastic laminate structure 316 and beam member 314 are preformed as a single, unitary structure—i.e., formed as a constrained layer viscoelastic material. Alternatively, the viscoelastic laminate structure 316 of FIG. 4 may be a stick-on viscoelastic laminate structure, such as first, second and third planar viscoelastic laminate structures 216A-216C of FIG. 3.

The viscoelastic laminate structure 316 includes an engineered viscoelastic layer 318 enclosed or surrounded, at least in part, by a constraining layer 120 and the beam member 114 (acting as a secondary constraining layer). The viscoelastic layer 318 spans substantially the entirety of the constraining layer 320, and is bonded, attached or adhered (e.g., by a high tack polymer) to the beam member 314 along a first interface surface 315, and similarly attached along an second interface surface 117 to the constraining layer 320. The viscoelastic layer 318 is fabricated from either a natural rubber or a synthetic material, preferably in the nature of a high strength damping polymer. In addition, the constraining layer 320 is formed from a material with the necessary stiffness to provide support to the viscoelastic layer 318, such as polymers, plastics, aluminum, magnesium, titanium, and steel. In accordance with preferred practices, the material for the beam member 314 and constraining layer 320 is draw quality cold rolled steel.

While the preferred embodiments and best modes for carrying out the present invention have been described in detail hereinabove, those familiar with the art to which this invention pertains will recognize various alternative designs and embodiments for practicing the invention within the scope of the appended claims.

1. A rail assembly for a door opening system including a prime mover in driving communication with a trolley that is operatively attached to a movable door, the prime mover being operable to selectively reposition the trolley and thereby transition the movable door between a substantially closed and a generally open position, the rail assembly comprising:
at least one beam member configured for mounting to a support structure, and further configured to slidably support the trolley member thereon; and
a viscoelastic laminate structure operatively attached to said at least one beam member to dissipate structure-borne noise generated therefrom.

2. The rail assembly of claim 1, wherein said viscoelastic laminate structure includes:
a constraining layer; and
a viscoelastic layer spanning substantially the entirety of and bonded to said constraining layer.

3. The rail assembly of claim 2, wherein said viscoelastic laminate structure includes a plurality of substantially planar viscoelastic laminate structures.

4. The rail assembly of claim 3, wherein each of said plurality of planar viscoelastic laminate structures includes an adhesive layer spanning substantially the entirety of a respective viscoelastic layer such that each of said plurality of viscoelastic laminate structures may be individually adhered at different predetermined locations along said at least one beam member.

5. The rail assembly of claim 2, wherein said viscoelastic laminate structure and said at least one beam member are preformed as a unitary structure.

6. The rail assembly of claim 2, wherein said constraining layer comprises one of a metallic material and a polymeric material.

7. The rail assembly of claim 6, wherein said constraining layer comprises steel.

8. The rail assembly of claim 2, wherein said viscoelastic layer comprises one of a natural rubber and a synthetic material.

9. The rail assembly of claim 2, wherein said at least one beam member has one of box-shaped cross-section and a T-shaped cross-section.

10. A garage door opening system in operable communication with a movable door, the garage door opening system comprising:
at least one beam member configured for mounting to a support structure;
a trolley operatively attached to the movable door, said trolley being slidably supported on said at least one beam member to transition between first and second positions;
a motor in driving communication with said trolley to selectively reposition said trolley between said first and second positions and thereby transition the movable door between a substantially closed and a generally open position; and
a viscoelastic laminate structure operatively attached to said at least one beam member to absorb and attenuate vibration and structure-borne noise directly from said at least one beam member.

11. The garage door opening system of claim 10, wherein said viscoelastic laminate structure includes:
a constraining layer; and
a viscoelastic layer spanning substantially the entirety of said constraining layer, said viscoelastic layer disposed between and bonded to said constraining layer and said at least one beam member.

12. The garage door opening system of claim 11, wherein said viscoelastic laminate structure includes a plurality of planar viscoelastic laminate structures.

13. The rail assembly of claim 12, wherein each of said plurality of planar viscoelastic laminate structures includes an adhesive layer spanning substantially the entirety of a respective viscoelastic layer such that each of said plurality of viscoelastic laminate structures may be individually adhered at different predetermined locations along said at least one beam member.

14. The rail assembly of claim 11, wherein said viscoelastic laminate structure and said at least one beam member are preformed as a unitary structure.

15. The rail assembly of claim 11, wherein said constraining layer comprises one of a metallic material and a polymeric material.

16. The rail assembly of claim 11, wherein said constraining layer comprises steel.

17. The rail assembly of claim 11, wherein said viscoelastic layer comprises one of a natural rubber and a synthetic material.

18. The rail assembly of claim 11, wherein said at least one beam member has one of box-shaped cross-section and a T-shaped cross-section.
